(19) United States
(12) Patent Application Publication
(10) Pub. No.: US 2026/0086027 A1
(43) Pub. Date: Mar. 26, 2026

(54) MATERIAL RECOGNITION DEVICE AND MATERIAL RECOGNITION METHOD

(71) Applicant: PIXART IMAGING INC., Hsin-Chu County (TW)

(72) Inventors: Wei-Chung WANG, Hsin-Chu County (TW); Chih-Ming SUN, Hsin-Chu County (TW)

(21) Appl. No.: 18/895,388

(22) Filed: Sep. 25, 2024

(51) Int. Cl. G01N 21/3563; A47L 11/40

(52) U.S. Cl. CPC G01N 21/3563; A47L 11/4002; A47L 11/4011; A47L 2201/06

(57) ABSTRACT

There is provided a surface material recognition device including a light source, a first photodiode, a second photodiode and a processor. The light source is used to illuminate a working surface. The first photodiode has a first detection wavelength range, and is used to output a first detection signal having first detection intensity. The second photodiode has a second detection wavelength range, different from the first detection wavelength range, and is used to output a second detection signal having second detection intensity. The processor recognizes a material of the working surface according to a combination of the first detection intensity and the second detection intensity.

### FIELD OF THE DISCLOSURE

This disclosure generally relates to a surface material recognition and, more particularly, to a material recognition device and a material recognition method that adopt a broadband light source to illuminate a working surface and a combination of detection light intensity of multiple narrowband photodiodes to recognize different surface materials of the working surface.

### BACKGROUND OF THE DISCLOSURE

With the operation functions of cleaning robots being gradually increased, it is possible to perform different functions corresponding to different working surfaces. Accordingly, how to correctly recognize the material of a surface is a key requirement to implement the above different functions.

Currently, a method to recognize the type of a working surface is to use an image sensor to acquire an image frame of the working surface, and the machine learning algorithm is used to perform the texture recognition on the image frame to classify the material. However, this machine learning algorithm requires a high amount of computation.

The information disclosed in this BACKGROUND is merely intended to increase understanding of the general background of the invention and should not be taken as an admission or in any way implied that the relevant information constitutes prior art that is already known to a person of ordinary skill in the art

### SUMMARY

Accordingly, the present disclosure provides a material recognition device and a material recognition method that use a combination of multiple detection intensity of multiple photodiodes having different detection wavelength ranges to perform the material classification that can reduce the computation amount requirement.

The present disclosure further provides a material recognition device that records a mapping table regarding different light wavelength intensity combinations corresponding to different surface materials for being compared by a processor with detection light intensity acquired by multiple photodiodes during operation.

The present disclosure provides a material recognition device including a light source, a first photodiode, a second photodiode and a processor. The light source is configured to illuminate a working surface. The first photodiode has a first detection wavelength range, and is configured to output a first detection signal having first detection intensity. The second photodiode has a second detection wavelength range, different from the first detection wavelength range, and is configured to output a second detection signal having second detection intensity. The processor is configured to recognize a material of the working surface according to a combination of the first detection intensity and the second detection intensity.

The present disclosure further provides a material recognition device including a light source, multiple photodiodes and a processor. The light source is configured to illuminate a working surface. The multiple photodiodes are arranged at a side of the light source in a first direction and form a one-dimensional array in a second direction perpendicular to the first direction, wherein the multiple photodiodes respectively have a predetermined detection wavelength range different from one another and is configured to output a detection signal having detection intensity. The processor is configured to recognize a material of the working surface according to a combination of multiple detection intensity of the multiple photodiodes.

The present disclosure further provides a material recognition method of a material recognition device. The material recognition device includes a light source, multiple photodiodes and a processor. The material recognition method includes the steps of: lighting the light source to illuminate a working surface; detecting, by the multiple photodiodes, reflected light from the working surface to output multiple detection signals having multiple detection intensity associated with multiple light wavelength ranges; and recognizing, by the processor, a material of the working surface according to a combination of the multiple detection intensity.

### BRIEF DESCRIPTION OF DRAWINGS

Other objects, advantages, and novel features of the present disclosure will become more apparent from the following detailed description when taken in conjunction with the accompanying drawings.

FIG. 1 is a side view of a material recognition device according to one embodiment of the present disclosure.

FIG. 2 is a schematic diagram of the arrangement of a light source and photodiodes of a material recognition device according to one embodiment of the present disclosure.

FIG. 3 is a schematic diagram of a mapping table of a material recognition device according to one embodiment of the present disclosure.

FIG. 4 is a flow chart of a material recognition method of a material recognition device according to one embodiment of the present disclosure.

### DETAILED DESCRIPTION OF THE DISCLOSURE

It should be noted that, wherever possible, the same reference numbers will be used throughout the drawings to refer to the same or like parts.

One objective of the present disclosure is to provide a surface material recognition device that recognizes a material of a working surface not according to an image frame captured by an image sensor so as to reduce the computation amount requirement. The present disclosure recognizes a material of a working surface by comparing detection light intensity of multiple photodiodes (e.g., at least two photodiodes) with predetermined light intensity combinations. The present disclosure may use, for example, a complicated machine learning classification algorithm or use a simple predetermined mapping table to perform the material recognition of the working surface. The detection light intensity of multiple photodiodes is not used to form an image frame to form a texture of the working surface.

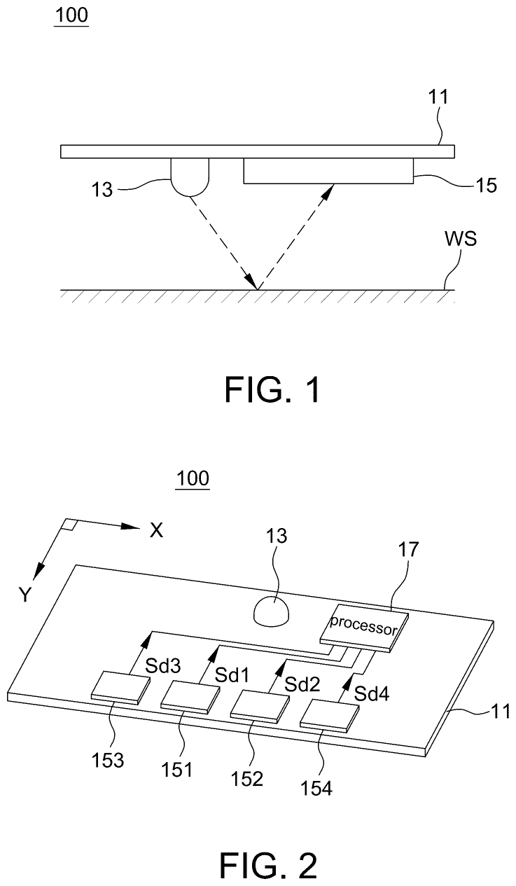

Please refer to FIG. 1, it is a side view of a material recognition device 100 according to one embodiment of the present disclosure. The material recognition device 100 is arranged on a navigation device such as a cleaning robot or an optical mouse, but not limited to, to recognize a material of a working surface WS for executing different functions, which are determined according to different applications. The working surface WS is, for example, a floor or a table surface on which the material recognition device 100 is operated.

Please refer to FIG. 2, it is a schematic diagram of the arrangement of a light source and photodiodes of a material recognition device 100 according to one embodiment of the present disclosure. The material recognition device 100 is shown to include a substrate 11, a light source 13, a processor 17 and multiple photodiodes, e.g., four photodiodes 151 to 154 being shown, but not limited to four. Because FIG. 1 shows a side view of the material recognition device 100, only one photodiode 15 is shown to represent propagation of a light path.

In one aspect, the substrate 11, the light source 13, the processor 17 and the multiple photodiodes are arranged in the same sensor chip, e.g., a complementary metal-oxide semiconductor readout integrated circuit (CMOS ROIC), and the processor 17 processes detection signals generated by the multiple photodiodes. In another aspect, the sensor chip outputs the detection signals of the multiple photodiodes to an external processor outside the sensor chip for the post-processing, e.g., the data comparison and material recognition mentioned below.

The processor 17 is, for example, a digital signal processor (DSP), an application specific integrated circuit (ASIC), a micro controller unit (MCU) or a field programmable gate array (FPGA) that implements the functions thereof using software, firmware and/or hardware, e.g., performing the data comparison and material recognition mentioned below.

The substrate 11 is, for example, a printed circuit board (PCB) or a flexible board without particular limitations.

The light source 13 is arranged on the substrate 11, and used to illuminate a working surface WS opposite to the light source 13 using a recognizable light. In the present disclosure, the light source 13 preferable outputs light having a wide wavelength range, e.g., from 400 nm to 2000 nm. For example, the light source 13 includes a shortwave infrared (SWIR) light source. In the case that a single light source is not able to cover the whole required wavelength range, the material recognition device 100 further includes another light source (e.g., light source emitting visible light) arranged on the substrate 11 for illuminating light together with the light source 13. In other words, the material recognition device 100 of the present disclosure may include more than one light source without being limited to a single light source.

The multiple photodiodes are, for example, organic photodiodes, but not limited to as long as they are able to detect light emitted by the light source 13. The multiple photodiodes are arranged on the substrate 11. The multiple photodiodes are arranged to have different detection wavelength ranges, e.g., implemented by coating different filtering layers to cause different photodiodes to detect different light wavelengths. The detection wavelength ranges used in the present disclosure are selected from the light wavelengths having high discrimination toward different materials (e.g., including soft material and hard material) of the working surface WS, e.g., at least including a light wavelength range between 1450 nm and 1500 nm. Said high discrimination means that the same light wavelength has different reflectivity with respect to different materials. The detection wavelength ranges used in the present disclosure are obtained before shipment by using the light source 13 to illuminate different surfaces (e.g., including carpet with short hairs, carpet with long hairs, wood surface, tile surface, glass surface, cement surface or the like) and by analyzing a combination of detection light intensity of different detection wavelength ranges, i.e. different surfaces having different combinations of detection light intensity.

In addition, the material and the detection wavelength ranges of the photodiodes are described at least one mentioned below.

First, the ultraviolet (UV) range: a wavelength range approximately between 100 nm and 400 nm. The material can be Poly(3-hexylthiophene) (P3HT) which can be effective in an upper part of the UV spectrum, Poly(4,4′-cyclohexylidene-diphenol) (PDP) which can be used for UV light detection, or fluorinated organic materials which can be such as fluorinated P3HT, enhancing sensitivity in this range.

Second, the visible light range: a wavelength range approximately between 400 nm and 700 nm. The material can be Poly(3-hexylthiophene) (P3HT) which can be effective across the visible spectrum, from red (around 600-700 nm) to green (around 500-550 nm), fullerene derivatives (e.g., [6,6]-Phenyl-C61-butyric acid methyl ester (PCBM)) which can extend absorption into the visible range, or Poly(vinylcarbazole) (PVK) which is sensitive to visible light, including blue (around 400-500 nm) and green light.

Third, the near-Infrared (NIR) range: a wavelength range approximately between 700 nm to 2500 nm. The material can be Poly(thieno[3,4-b]thiophene) (PTB7) which can be effective for near-infrared detection, typically in the 700-1000 nm range, low bandgap polymers (e.g., Poly(thieno[3,4-b]thiophene-co-benzothiadiazole) (PFFBT4T-2OD)) which absorb in the near-infrared range (extending up to 1500-2000 nm), metal-organic frameworks (MOFs) which can be investigated for near-infrared detection, often covering 800-2000 nm.

Fourth, the mid-infrared (MIR) range: a wavelength range approximately between 2500 nm to 5000 nm. The material can be advanced conjugated polymers such as being developed for mid-infrared detection, potentially covering the 2500-4000 nm range.

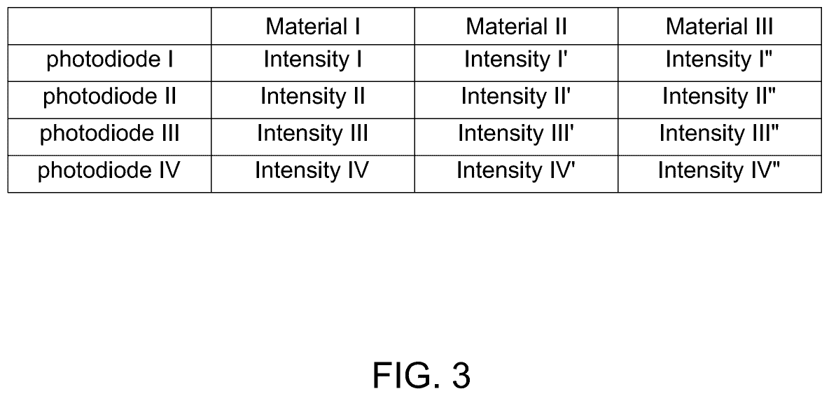

The material recognition device 100 further includes a memory (not shown) to record a mapping table, e.g., referring to FIG. 3, of predetermined intensity combinations and corresponding photodiodes associated with different materials. FIG. 3 shows the intensity distributions of different photodiodes I to IV corresponding to different material I, material II and material III, wherein the Intensity I to III are different from one another; the Intensity I, I′ and I″ are different from one another; the Intensity II, II′ and II″ are different from one another; the Intensity III, III′ and III″ are different from one another; and the Intensity IV, IV′ and IV″ are different from one another. The processor 17 compares the mapping table with a combination of current detection intensity generated by multiple photodiodes (e.g., shown as photodiodes I to IV) to determine a surface material. It should be mentioned that a number of photodiodes and materials shown in FIG. 3 are only intended to illustrate but not to limit the present disclosure.

Please refer to FIGS. 2 and 3, in one aspect, the material recognition device 100 includes, for example, a first photodiode 151 and a second photodiode 152. The first photodiode 151 has a first detection wavelength range and is used to output a first detection signal Sd1 having first detection intensity. The second photodiode 152 has a second detection wavelength range, different from the first detection wavelength range, and is used to output a second detection signal Sd2 having second detection intensity. In this aspect, the first detection wavelength range is partially overlapped or totally not overlapped with the second detection wavelength range, determined according to the reflecting response of different materials. The processor 17 is used to recognize a material of the working surface WS according to a combination of the first detection intensity and the second detection intensity.

For example, a memory previously (before shipment) stores a mapping table (referring to FIG. 3) of different materials of the working surface WS versus different combinations of the first detection intensity and the second detection intensity for being compared by the processor 17.

The combinations of the first detection intensity and the second detection intensity include at least one of: (i) a stronger one and a weaker one of the first detection intensity and the second detection intensity; (ii) an intensity ratio between the first detection intensity and the second detection intensity; and (iii) an intensity variation range of the first detection intensity and the second detection intensity, respectively. These combinations are measured before shipment and recorded in the memory for being real-timely compared/accessed by the processor 17.

Please refer to FIGS. 2 and 3 again, in another aspect, the material recognition device 100 includes multiple photodiodes (e.g., 151 to 154, but not limited to four), and the multiple photodiodes are arranged at a side of the light source 13 in a first direction (e.g., shown as direction Y), and arranged as one-dimensional array in a second direction (e.g., shown as direction X) perpendicular to the first direction. In this aspect, the multiple photodiodes 151 to 154 respectively have a predetermined detection wavelength range different from one another (e.g., detection wavelength ranges not overlapped at all or partially overlapped) and respectively output a detection signal, e.g., shown as Sd1 to Sd4, having detection intensity, respectively.

In the aspect that the material recognition device 100 is arranged on a cleaning robot, the first direction Y is a moving direction of the cleaning robot.

The processor 17 is used to recognize a material of the working surface WS according to a combination of multiple detection intensity of the multiple photodiodes 141 to 154. As mentioned above, a memory of the material recognition device 100 previously stores a mapping table (e.g., referring to FIG. 3) of different materials of the working surface WS versus different combinations of the multiple detection intensity for being compared by the processor 17.

In one aspect, the combination of the multiple detection intensity includes maximum intensity and minimum intensity among the multiple detection intensity, and includes photodiodes corresponding to the maximum intensity and the minimum intensity. For example in FIG. 3, the photodiodes having the maximum intensity and the minimum intensity corresponding to the material I, the material II and the material III are different, and thus the processor 17 is able to distinguish different materials once the photodiodes having the maximum intensity and the minimum intensity being identified. Before shipment, the maximum intensity and the minimum intensity among the multiple detection intensity are actually measured and recorded as the mapping table by using the light source 13 to illuminate different materials.

In another aspect, the combination of the multiple detection intensity includes an intensity sequence of all of or a part of the multiple detection intensity, and includes photodiodes corresponding to the all of or the part of the multiple detection intensity. For example in FIG. 3, intensity sequences (e.g., from large to small) associated with the material I, the material II and the material III are different, and thus the processor 17 is able to distinguish different materials after a current intensity sequence of the photodiodes is identified. Before shipment, different intensity sequences among the multiple detection intensity are actually measured and recorded as the mapping table by using the light source 13 to illuminate different materials.

In a further aspect, the combination of the multiple detection intensity includes intensity variation ranges of all of or a part of the multiple detection intensity, and includes photodiodes corresponding to the all of or the part of the multiple detection intensity. During operation, the multiple detection intensity is not constant values but is change within an intensity range corresponding to different materials. Before shipment, different variation ranges among the multiple detection intensity are actually measured and recorded as the mapping table by using the light source 13 to illuminate different materials.

In other words, the processor 17 is not limited to compare detection intensity of all photodiodes every time, but is able to recognize some predetermined materials when the detection intensity of a part of photodiodes matches the mapping table so as to reduce the computation amount requirement. That is, the material recognition device 100 of the present disclosure is arranged with a plurality of photodiodes to increase the recognizable types of material, but uses only a part of detection intensity having high discrimination in the comparison process.

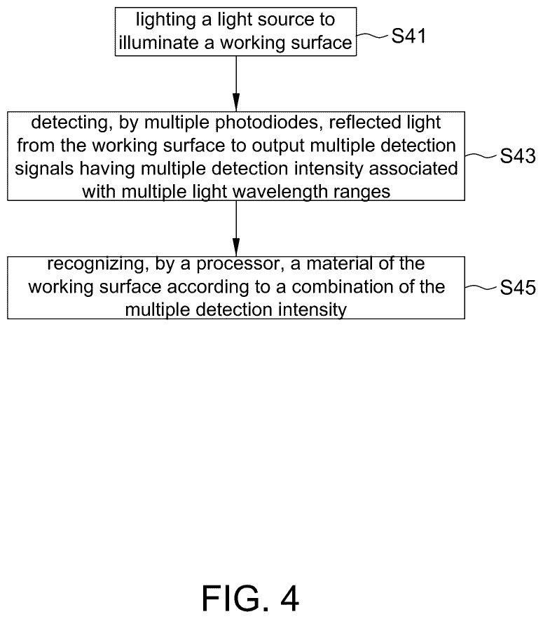

Please refer to FIG. 4, it is a flow chart of a material recognition method of a material recognition device according to one embodiment of the present disclosure, e.g., adapted to the material recognition device 100 shown in FIGS. 1 and 2.

Please refer to FIGS. 2 to 4, the material recognition method of the present disclosure includes the steps of: lighting a light source 13 to illuminate a working surface WS (Step S41); detecting, by multiple photodiodes 151 to 154, reflected light from the working surface WS to output multiple detection signals, e.g., Sd1 to Sd4, having multiple detection intensity associated with multiple light wavelength ranges (Step S43); and recognizing, by a processor 17, a material of the working surface WS according to a combination of the multiple detection intensity (Step S45).

As mentioned above, the processor 17 compares a combination of the multiple detection intensity with predetermined intensity combinations (e.g., referring to FIG. 3) to recognize the material of the working surface WS. Details of the combination of the multiple detection intensity have been illustrated above, and thus are not repeated herein.

It should be mentioned that although the drawings of the present disclosure show that the multiple photodiodes are separated by a distance therebetween, the present disclosure is not limited thereto. In other aspects, a part of or all of the multiple photodiodes are directly adjacent to each other without a space therebetween. In another aspect, the same detection wavelength range may include more than one photodiodes to increase the signal-to-noise ratio.

It should be mentioned that although the drawings of the present disclosure show that the multiple photodiodes are arranged to form a one-dimensional array along the second direction as an example, the present disclosure is not limited thereto. In other aspects, the multiple photodiodes are arranged as a matrix and have a different number, which is determined according to a number of wavelength ranges used in constructing the mapping table.

As mentioned above, since a cleaning robot needs to recognize a working surface to perform different functions, the ability of recognizing a material of the working surface is required. However, the present machine learning algorithm classifies the material using an image frame and requires a high computation amount. Accordingly, the present disclosure further provides a surface material recognition device (e.g., referring to FIGS. 1-2) and a material recognition method thereof (e.g., referring to FIG. 4) that classifies different surface material by comparing multiple detection light intensity of multiple photodiodes with predetermined intensity combinations. The light wavelength ranges associated with the multiple detection light intensity are selected as ranges having high discrimination toward different materials, and can be actually measured before shipment.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. A material recognition device, comprising:
a light source, configured to illuminate a working surface;
a first photodiode, having a first detection wavelength range, and configured to output a first detection signal having first detection intensity;
a second photodiode, having a second detection wavelength range, different from the first detection wavelength range, and configured to output a second detection signal having second detection intensity; and
a processor, configured to recognize a material of the working surface according to a combination of the first detection intensity and the second detection intensity.

2. The material recognition device as claimed in claim 1, wherein the light source comprises a short wave infrared light source.

3. The material recognition device as claimed in claim 1, wherein the first photodiode and the second photodiode are organic photodiodes.

4. The material recognition device as claimed in claim 1, further comprising a memory configured to previously store a mapping table of different materials of the working surface versus different combinations of the first detection intensity and the second detection intensity for being compared by the processor.

5. The material recognition device as claimed in claim 1, wherein one of the first detection wavelength range and the second detection wavelength range comprises at least one of an ultraviolet range, a visible light range, a near-Infrared range and a mid-infrared range.

6. The material recognition device as claimed in claim 1, wherein the combination of the first detection intensity and the second detection intensity comprises at least one of:
a stronger one and a weaker one of the first detection intensity and the second detection intensity;
an intensity ratio between the first detection intensity and the second detection intensity; and
an intensity variation range of the first detection intensity and the second detection intensity, respectively.

7. A material recognition device, comprising:
a light source, configured to illuminate a working surface;
multiple photodiodes, arranged at a side of the light source in a first direction and forming a one-dimensional array in a second direction perpendicular to the first direction, wherein the multiple photodiodes respectively have a predetermined detection wavelength range different from one another and is configured to output a detection signal having detection intensity; and
a processor, configured to recognize a material of the working surface according to a combination of multiple detection intensity of the multiple photodiodes.

8. The material recognition device as claimed in claim 7, wherein the light source comprises a short wave infrared light source.

9. The material recognition device as claimed in claim 7, wherein the multiple photodiodes are organic photodiodes.

10. The material recognition device as claimed in claim 7, wherein the material recognition device is arranged on a cleaning robot, and the first direction is a moving direction of the cleaning robot.

11. The material recognition device as claimed in claim 7, further comprising a memory configured to previously store a mapping table of different materials of the working surface versus different combinations of the multiple detection intensity for being compared by the processor.

12. The material recognition device as claimed in claim 7, wherein one of the multiple detection wavelength ranges comprises at least one of an ultraviolet range, a visible light range, a near-Infrared range and a mid-infrared range.

13. The material recognition device as claimed in claim 7, wherein the combination of the multiple detection intensity comprises:
maximum intensity and minimum intensity among the multiple detection intensity, and
photodiodes corresponding to the maximum intensity and the minimum intensity.

14. The material recognition device as claimed in claim 7, wherein the combination of the multiple detection intensity comprises:
an intensity sequence of all of or a part of the multiple detection intensity, and
photodiodes corresponding to the all of or the part of the multiple detection intensity.

15. The material recognition device as claimed in claim 7, wherein the combination of the multiple detection intensity comprises:
intensity variation ranges of all of or a part of the multiple detection intensity, and
photodiodes corresponding to the all of or the part of the multiple detection intensity.

16. A material recognition method of a material recognition device, the material recognition device comprising a light source, multiple photodiodes and a processor, the material recognition method comprising:
lighting the light source to illuminate a working surface;
detecting, by the multiple photodiodes, reflected light from the working surface to output multiple detection signals having multiple detection intensity associated with multiple light wavelength ranges; and
recognizing, by the processor, a material of the working surface according to a combination of the multiple detection intensity.

17. The material recognition method as claimed in claim 16, wherein the processor compares the combination of the multiple detection intensity with predetermined intensity combinations to recognize the material of the working surface.

18. The material recognition method as claimed in claim 16, wherein the combination of the multiple detection intensity comprises:
maximum intensity and minimum intensity among the multiple detection intensity, and
photodiodes corresponding to the maximum intensity and a minimum intensity.

19. The material recognition method as claimed in claim 16, wherein combination of the multiple detection intensity comprises:
an intensity sequence of all of or a part of the multiple detection intensity, and
photodiodes corresponding to the all of or the part of the multiple detection intensity.

20. The material recognition method as claimed in claim 16, wherein the combination of the multiple detection intensity comprises:
intensity variation ranges of all of or a part of the multiple detection intensity, and
photodiodes corresponding to the all of or the part of the multiple detection intensity.
